(19) United States
(12) Patent Application Publication
(10) Pub. No.: US 2025/0117177 A1
(43) Pub. Date: Apr. 10, 2025

(54) CONTROL METHOD AND DEVICE AND FIRST ELECTRONIC DEVICE

(71) Applicant: Lenovo (Beijing) Limited, Beijing (CN)

(72) Inventors: Shuang HAN, Beijing (CN); Zhiyong LU, Beijing (CN); Xiaoxi CHEN, Beijing (CN)

(21) Appl. No.: 18/908,235

(22) Filed: Oct. 7, 2024

(30) Foreign Application Priority Data
Oct. 7, 2023 (CN) 202311287697.0

(51) Int. Cl. G06F 3/14; G06F 1/26; G06F 1/3234

(52) U.S. Cl. CPC G06F 3/1423; G06F 1/266; G06F 1/3265

(57) ABSTRACT

A control method includes: outputting first image data of a first electronic device, obtaining a first control instruction, and switching to outputting second image data of a second electronic device. The first control instruction is used to control the first electronic device to switch from a first state to a second state. The power consumption of the first electronic device in the first state being greater than the power consumption in the second state. The second electronic device is communicatively connected with the first electronic device.

### CROSS-REFERENCES TO RELATED APPLICATION

This application claims priority to Chinese Patent Application No. 202311287697.0 filed on Oct. 7, 2023, the entire content of which is incorporated herein by reference.

### FIELD OF TECHNOLOGY

The present disclosure relates to a control method and device, and a first electronic device.

### BACKGROUND

When two devices have a communication connection and work cooperatively, since the other device connected to the electronic device is not aware of the actual operating state of the electronic device, when the other device is turned off, the electronic device will be powered off. This will cause abnormalities such as a blue screen when the electronic device is turned on next time.

### SUMMARY

One aspect of this disclosure provides a control method. The method includes outputting first image data of a first electronic device, obtaining a first control instruction, and switching to outputting second image data of a second electronic device. The first control instruction is used to control the first electronic device to switch from a first state to a second state. The power consumption of the first electronic device in the first state being greater than the power consumption in the second state. The second electronic device is communicatively connected with the first electronic device.

Another aspect of the present disclosure provides a control device. The control device includes an acquisition module and a control module. The acquisition module is configured to obtain a first control instruction. The first control instruction is used to control a first electronic device to switch from a first state to a second state, and the power consumption of the first electronic device in the first state being greater than the power consumption in the second state. The control module is configured to control the first electronic device to output second image data related to a second electronic device in response to the first control instruction. The second electronic device is communicatively connected with the first electronic device.

Another aspect of the present disclosure provides a first electronic device. The first electronic device includes a processing device, a first interface, and an output device. The processing device is configured to generate first image data. The first interface is connected to a second electronic device, and is used to obtain second image data output by the second electronic device. The output device is configured to output the first image data or output the second image data and obtain a first control instruction. The first control instruction is used to control a first electronic device to switch from a first state to a second state. The power consumption of the first electronic device in the first state is greater than the power consumption in the second state. The processing device is further configured to control the output device to switch from outputting the first image data to outputting the second image data in response to the first control instruction.

### BRIEF DESCRIPTION OF THE DRAWINGS

To more clearly illustrate the technical solution in the present disclosure, the accompanying drawings used in the description of the disclosed embodiments are briefly described hereinafter. The drawings are not necessarily drawn to scale. Similar drawing labels in different drawings refer to similar components. Similar drawing labels with different letter suffixes refer to different examples of similar components. The drawings described below are merely some embodiments of the present disclosure. Other drawings may be derived from such drawings by a person with ordinary skill in the art without creative efforts and may be encompassed in the present disclosure.

FIG. 1 is a flowchart of a control method according to some embodiments of the present disclosure.

FIG. 2 is a flowchart of the control method according to some embodiments of the present disclosure.

FIG. 3 is a flowchart of the control method according to some embodiments of the present disclosure.

FIG. 4 is a flowchart of the control method according to some embodiments of the present disclosure.

FIG. 5 is a flowchart of the control method according to some embodiments of the present disclosure.

FIG. 6 is a flowchart of the control method according to some embodiments of the present disclosure.

FIG. 7 is a schematic structural diagram of a control device according to some embodiments of the present disclosure.

FIG. 8 is a schematic structural diagram of a first electronic device according to some embodiments of the present disclosure.

FIG. 9 is a schematic diagram of the hardware of an electronic device according to some embodiments of the present disclosure.

### DETAILED DESCRIPTION

It should be understood that the specific embodiments described herein are only used to explain the present disclosure, but not to limit the present disclosure.

In the following description, the use of suffixes such as “module”, “component”, or “unit” for indicating elements is merely for the benefit of the description of the present disclosure, and they do not have specific meanings by themselves. Therefore, “modules,” “components,” or “units” can be used in combination.

Electronic devices can be implemented in various forms. For example, the electronic devices described in the present disclosure may include mobile electronic devices such as personal digital assistants (PDAs), navigation devices, wearable devices, and fixed electronic devices such as digital TVs and desktop computers that can perform fingerprint collection.

The following description will take a first electronic device and a second electronic device as examples. Those skilled in the art should understand that in addition to elements specifically for mobile purposes, the configuration according to the embodiments of the present disclosure can also be applied to fixed-type electronic devices.

Based on this, an embodiment of the present disclosure provides a control method that is applicable to a first electronic device and a second electronic device. Consistent with the present disclosure, the second image data can be output through the first electronic device to understand the state of the second electronic device, thereby avoiding abnormal power failure causing a blue screen when the second electronic device is turned on next time, and improving the operational stability of the second electronic device.

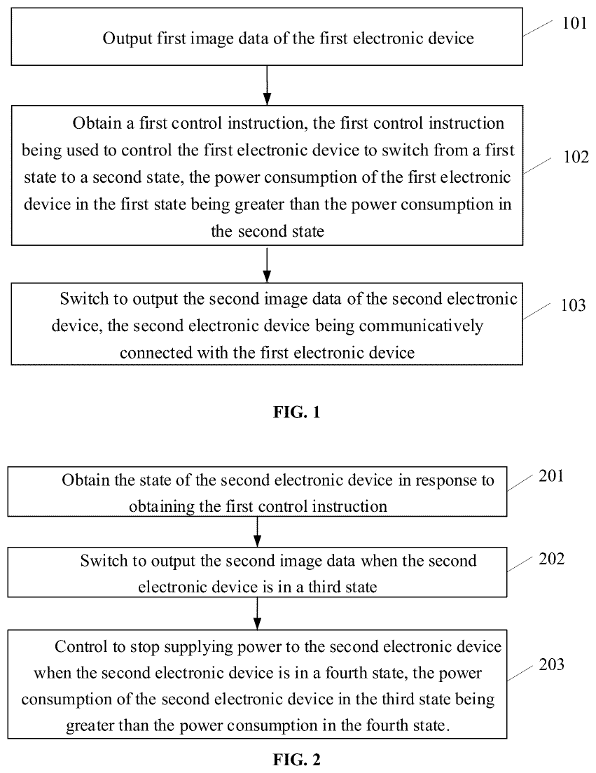

FIG. 1 is a flowchart of a control method according to some embodiments of the present disclosure. The method will be described in detail below.

101, outputting first image data of the first electronic device.

The first electronic device may have a corresponding first operating system and may have the ability to independently process computing data. The first image data may correspond to the first electronic device and is the image data generated when the first electronic device is operating normally. The first electronic device may output the first image data by screen display, or output the first image data to other devices by data transmission. The first image data can be output by the first electronic device.

102, obtaining a first control instruction, the first control instruction being used to control the first electronic device to switch from a first state to a second state, the power consumption of the first electronic device in the first state being greater than the power consumption in the second state.

The first electronic device may obtain the first control instruction through an interface or wirelessly, for example, by clicking a control with a mouse, by wireless remote control, or by voice control or other control methods. The first electronic device may switch back and forth between a first state and a second state. The first state may indicate that the first electronic device is in a power-on state. In the first state, the first electronic device may provide the second electronic device with a voltage that enables the second electronic device to work normally, and both the first electronic device and the second electronic device may be powered. The second state may indicate that the first electronic device is in a state with lower power consumption than the power-on state, which may include a sleep state and a power-off state. In the second state, the first electronic device may stop providing the electronic device with a voltage that enables the second electronic device to work normally. The first state and the second state may be flexibly adjusted based on different states of the first electronic device. The first control instruction may be an instruction for controlling the first electronic device to switch from a current state to another state with lower power consumption, such as a shutdown instruction or a sleep instruction. The first electronic device may obtain the first control instruction to control the first electronic device to switch from the first state to the second state.

103, switching to outputting the second image data of the second electronic device, the second electronic device being communicatively connected with the first electronic device.

The second electronic device may have a corresponding second operating system and may have the ability to independently process computing data. the second operating system of the second electronic device and the first operating system of the first electronic device may be the same or different. The second image data may correspond to the second electronic device, and may include information on the operating state of an application in the second electronic device. The second electronic device may establish a communication connection with the first electronic device through electrical, mechanical or other means. The first electronic device may switch the output of the first image data to the output of the second image data.

The power supply of the second electronic device may come from the power supply of the first electronic device. Therefore, in the second state, the first electronic device may not supply power to the outside or the power supply power may be low as the first electronic device has no power consumption demand or low power consumption demand. This may cause the second electronic device to shut down due to abnormal power failure.

Consistent with the present disclosure, the first electronic device can output the first image data, and after receiving the first control instruction, the first electronic device can switch to output the second image data of the second electronic device. The first control instruction can be used to control the first electronic device to switch from a first state to a second state. The power consumption of the first electronic device in the first state may be greater than the power consumption in the second state, and the second electronic device may have a communication connection with the first electronic device. In this way, when the first electronic device receives the first control instruction and switches to the second state, the second image data of the second electronic device can be displayed, thereby avoiding a blue screen caused by abnormal power failure when the state of the second electronic device is unclear, and improving the operational stability of the second electronic device when working in collaboration.

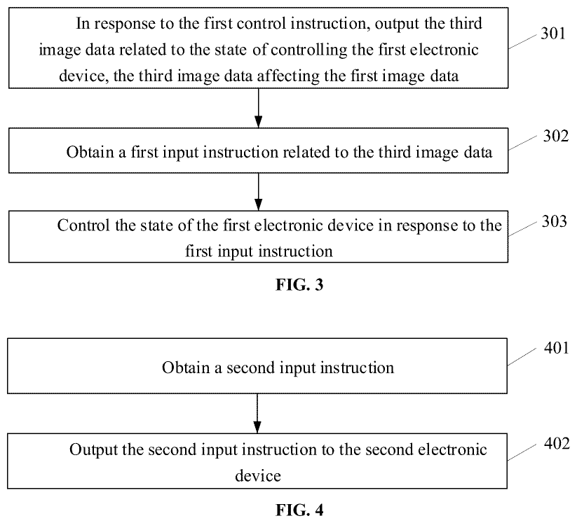

In some embodiments, the first electronic device may obtain the state of the second electronic device. FIG. 2 is a flowchart of the control method according to some embodiments of the present disclosure. The method will be described in detail below.

201, obtaining the state of the second electronic device in response to obtaining the first control instruction.

The state of the second electronic device may include four states of dormancy, sleep, power-on and power-off, or the state of the second electronic device may also include six states of S0, S1, S2, S3, S4 and S5. More specifically, the state of the second electronic device depends on the operating system running on the second electronic device. After obtaining the first control instruction, the first electronic device may obtain the state of the second electronic device.

202, switching to outputting the second image data when the second electronic device is in a third state.

203, controlling to stop supplying power to the second electronic device when the second electronic device is in a fourth state, the power consumption of the second electronic device in the third state being greater than the power consumption in the fourth state.

In some embodiments, the third state may be any state of the sleep state, the hibernation state or the power-on state, and the fourth state may be the power-off state. Or, the third state may be any state from S0 to S3, and the fourth state may be S4 or S5. When the second electronic device is in the third state, the first electronic device may switch to output the second image data of the second electronic device. When the second electronic device is in the fourth state, the first electronic device may be controlled to stop supplying power to the second electronic device.

Take the second electronic device including six working states of S0, S1, S2,S3, S4 and S5 as an example. The third state may correspond to any state from S0 to S3. The second electronic device being powered off in the third state may cause a blue screen after startup. The fourth state may correspond to the S4 or S5 state. After the second electronic device is powered off in the fourth state, restarting the second electronic device may not affect the normal use of the second electronic device and may not cause a blue screen. In some embodiments, the power consumption of S4 and S5 may be lower than the power consumption of any one of S0 to S3, and the power consumption of S4 may be higher than the power consumption of S5.

In some embodiments, in the S0 state, all functions of the second electronic device may be operating normally. At this time, the second electronic device is in the power-on state, and the power consumption is at the highest. In the S1 state, except for shutting down the CPU through the CPU clock controller, other parts of the second electronic device may still operate normally. That is, the second electronic device may be in a lower power supply state. In the operating system or boost system, the screen signal output may be set to be turned off, the hard disk may stop running and enter the standby state, and the power light may be in a flashing state. At this time, the second electronic device can be woken up by dragging the mouse or pressing any key on the keyboard. In the S2 state, all data currently stored in the operating system memory may be saved and then enter a “fake power-off” state. At this time, except for the memory which needs power to maintain data, power supply to all other devices and equipment may be stopped. In the S3 state, all data currently stored in the operating system memory may be saved and then enter a “fake power-off” state. At this time, except for the memory which needs power to maintain data, power supply to all other devices and equipment may be stopped. In the S4 state, the data in the operating system memory may be completely saved in the hard disk. When the second electronic device is turned on, the data may be read directly from the location where it is stored into the memory without having to run the application again. In the S5 state, all devices including the power supply may be turned off and in the power-off state, and the power consumption may be 0. Take the second electronic device including six working states of S0, S1, S2, S3, S4 and S5 as an example. The third state may correspond to any state from S0 to S3.

In some embodiments, take the second electronic device including four working states of power-on state, sleep state, hibernation state, and power-off state as an example. The third state may correspond to any state of the power-on state, the sleep state, and the hibernation state. The second electronic device being powered of in the third state may cause a blue screen after power on. The fourth state may correspond to the power-off state. After the second electronic device is powered off in the fourth state, restarting the second electronic device will not affect the normal use of the second electronic device, and no blue screen will appear. The power consumption in the power-off state may be lower than the power consumption in the sleep state or hibernation state, and the power consumption in the power-on state may be the highest.

In the embodiments of the present disclosure, the first electronic device may be further configured to obtain the state of the second electronic device after obtaining the first control instruction. When the second electronic device is in the third state, the first electronic device may be controlled to switch to output the second image data; when the second electronic device is in the fourth state, the first electronic device may be controlled to stop supplying power to the second electronic device. In this way, the first electronic device can output the second image data to stop outputting the second image data to the second electronic device based on the state of the second electronic device, thereby avoiding a blue screen caused by abnormal power failure when the second electronic device is in the third state, and improving the operational stability of the second electronic device when working in collaboration.

In some embodiments, the state of the first electronic device may be controlled based on the state of the second electronic device, which may include the following process: control the first electronic device to be in the second state, or stop to provide power to the first electronic device when the second electronic device is in the fourth state.

When the second electronic device is in the fourth state, the first electronic device can be controlled to switch from the first state to the second state. That is, the first electronic device can be controlled to switch from the power-on state to the power-off state or the sleep state. Alternatively, the power supply to the first electronic device can be stopped, and the first electronic device can be switched to the second state by powering off the first electronic device.

In some embodiments, when the second electronic device is in the fourth state, the first electronic device may be controlled to be in the second state, or the power supply to the first electronic device may be stopped. In this way, when the second electronic device is in a state where it can be powered off, the first electronic device can be controlled to switch to the second state or to be powered off, thereby enhancing the control over the first electronic device and improving the coordination capability between the first electronic device and the second electronic device.

In some embodiments, the first electronic device may output the corresponding image data based on the amount of time that the second electronic device is in the third state. More specifically, when the amount of time during which the second electronic device is in the third state does not reach a first duration, the first image data may be output.

The first duration may be preset and may be set based on the time normally required for the second electronic device to switch from the third state to the fourth state. The duration of the second electronic device being in the third state not reaching the first duration may indicate that the second electronic device has switched from the third state to the fourth state within the first duration. That is, the second electronic device is in a state where power off will not affect the next startup, and the first electronic device can normally display the first image data corresponding to the first electronic device. In this way, when the duration of the second electronic device being in the third state does not reach the first duration, the first electronic device can output the first image data.

In some embodiments, when the duration of the second electronic device being in the third state reaches the first duration, the first electronic device may be switched to output the second image data.

When the duration of the second electronic device being in the third state reaches the first duration, that is, the second electronic device does not switch from the third state to the fourth state within the first duration, in may indicate that an application is running in the second electronic device, and the second electronic device cannot be powered off. At this time, the power failure of the second electronic device will affect the next startup. Therefore, the first electronic device may switch to output the second image data through which the application state in the second electronic device can be understood, and the application that prevents power off can be determined. In this way, when the duration that the second electronic device is in the third state reaches the first duration, the first electronic device can output the second image data based on actual conditions.

In some embodiments, the first electronic device may output the first image data when the duration of the second electronic device being in the third state does not reach the first duration, and switch to output the second image data when the duration of the second electronic device being in the third state reaches the first duration. In this way, the first electronic device can determine the output image data based on the duration when the second electronic device is in the third state, thereby avoiding the first electronic device from continuously waiting and outputting the first image data when the second electronic device is in the third state for a long period of time. In this way, the first electronic device can flexibly output corresponding image data, enhance the control of the first electronic device, and improve the coordination between the first electronic device and the second electronic device.

In some embodiments, if the first electronic device does not obtain the state of the second electronic device within a preset time, the first electronic device may switch to the second state. More specifically, when the time period for which the state of the second electronic device is not obtained reaches a second duration, the first electronic device may be controlled to be in the second state, or power supply to the first electronic device may be stopped.

The second duration may be preset, such as 30 seconds. During the second duration, the first electronic device may be in the power-off state or sleep state, output the first image data, and wait to receive the state of the second electronic device. If the state of the second electronic device is not obtained within the second duration, the first electronic device may stop waiting and switch to the second state. Alternatively, the power supply to the first electronic device may be directly stopped such that the second electronic device is powered off and is in the second state.

In some embodiments, when the first electronic device does not obtain the state of the second electronic device for a period of time that reaches the second duration, the first electronic device may be controlled to switch to the second state, or the power supply to the first electronic device may be stopped. In this way, when the first electronic device does not obtain the state of the second electronic device for a long period of time, it will directly switch to the second state, or turn off the power, thereby preventing the first electronic device from being in a waiting state all the time, saving device resources, and improving device control capabilities.

In some embodiments, the first electronic device may determine the state of the first electronic device based on whether the image data of the second electronic device is obtained. More specifically, in response to obtaining the first control instruction, a second control instruction may be output to the second electronic device. The second control instruction may be used to control the second electronic device to switch from the third state to the fourth state, and the power consumption of the second electronic device in the third state may be greater than the power consumption in the fourth state.

The first electronic device may output the second control instruction to the second electronic device through an interface or wireless connection, and the second control instruction may be used to instruct the second electronic device to start powering off or entering the S4 state. The second control instruction may be generated by the first electronic device after the first electronic device obtains the first control instruction. The first electronic device may send the generated second control instruction to the second electronic device such that the second electronic device can switch from the third state to the fourth state. The power consumption of the second electronic device in the third state may be greater than the power consumption in the fourth state.

In some embodiments, the first electronic device may output the second control instruction to the second electronic device after receiving the first control instruction and before obtaining the state of the second electronic device. When the second electronic device receives the second control instruction and changes its current state based on the second control instruction, the first electronic device receives the changed state of the second electronic device and determines to output the second image data or stop supplying power to the second electronic device based on the new state of the second electronic device, thereby realizing the powering off of the second electronic device following the first electronic device.

In some embodiments, the second control instruction may control the second electronic device to switch from the current to another state with lower power consumption such as switching from S0 to any state from S1 to S5, switching from S1 to any state from S2 to S5, switching from S2 to any state from S3 to S5, switching from S3 to any state from S4 to S5, and switching from S4 to S5.

In some embodiments, when the first electronic device obtains the first control instruction, the first electronic device may output the second control instruction to the second electronic device to control the second electronic device to switch from the third state to the fourth state, and the power consumption of the second electronic device in the third state may be greater than the power consumption in the fourth state. In this way, when the first electronic device obtains the first control instruction, the second control instruction can be generated at the same time. The second control instruction may be used to control the second electronic device to follow the first electronic device and switch to a state with lower power consumption at the same time. In this way, the cooperation capability between the first electronic device and the second electronic device is improved.

In some embodiments, the first electronic device may switch to outputting the first image data by controlling to output the first image data and the second image data in a first output mode, and switch to output the first image data and the second image data in a second output mode. The first image data may affect the second image data in the first output mode, and the second image data may affect the first image data in the second output mode.

In the first output mode, the first image data is overlaid on the second image data such that the first image data will affect the display of the second image data. In the second output mode, the second image data may be overlaid on the first image data such that the second image data will affect the display of the first image data. When the first electronic device outputs the second image data, the first electronic device may switch to the second output mode to display the second image data on the first image data, thereby realizing the switching of the top layer display, and enabling the second image data to be fully displayed.

In some embodiments, the first electronic device may control the output of the first image data and the second image data in the first output mode, and switch to outputting the first image data and the second image data in the second output mode. In the first output mode, the first image data may affect the second image data, and in the second output mode, the second image data may affect the first image data. In this way, by switching the top layer display, the second image data can be switched to be displayed on the top layer such that the user can clearly and accurately understand the state of the second electronic device through the second image data, thereby avoiding abnormal power-off without knowing the state of the second electronic device and causing a blue screen on the next startup, and improving the operational stability of the second electronic device when working in collaboration.

In some embodiments, the first electronic device may also control the state of the first electronic device by outputting third image data. FIG. 3 is a flowchart of the control method according to some embodiments of the present disclosure. The method will be described in detail below.

301, in response to the first control instruction, outputting the third image data related to the state of controlling the first electronic device, the third image data affecting the first image data.

The third image data may be the power-off or sleep prompt information of the first electronic device, which can be used to instruct the user to control the state of the first electronic device. For example, the first control instruction may be to control the first electronic device to power off, and the corresponding third image data may be a dialog box to whether to power off the first electronic device. In some embodiments, the third image data may be overlaid on the first image data such that the third image data will affect the display of the first image data.

302, obtaining a first input instruction related to the third image data.

The first input instruction may be input into the first electronic device through a keyboard, a mouse, a remote control, a touch screen, etc. The first input instruction may be used to control the state of the first electronic device, and the user may input a corresponding instruction based on the output third image data. For example, if the third image data is “Confirm to power off?”, the corresponding control may be “Yes” and “No”, and the user can input the corresponding command by dragging the mouse to click. When the first input instruction is “Yes”, the first electronic device can be controlled to power off, otherwise, the power-off is canceled.

303, controlling the state of the first electronic device in response to the first input instruction.

The first electronic device can receive the first input instruction and control the state of the first electronic device based on the first input instruction. For example, the third image data may be a power-off instruction of “Confirm to power off?”, and the first input instruction may be “Yes”, indicating confirmation of power-off, then the first electronic device can be controlled to start powering off. Or, the third image data may be a sleep instruction of “Confirm to sleep?”, and the first input instruction may be “Yes”, indicating confirmation of sleep, then the first electronic device can be controlled to start sleep. Or, when the first input instruction is “No”, the first electronic device can be kept in the original operating state.

In some embodiments, the first input instruction may force the first electronic device to switch to the second state. That is, the first electronic device does not output the second image data of the second electronic device, and does not need to determine the state of the second electronic device, and directly switches to the second state.

Consistent with the present disclosure, when the first electronic device receives the first control instruction, the first electronic device can output the third image data related to the controlling of the state of the first electronic device, and the third image data affects the first image data. Subsequently, the first input instruction related to the third image data is received, thereby controlling the state of the first electronic device. In this way, the state of the first electronic device is controlled by the third image data. The control capability of the first electronic device is enhanced, and the efficiency of switching the state of the first electronic device is improved.

In some embodiments, after the first electronic device switches to outputting the second image data, the first electronic device may also obtain a second input instruction and send the second input instruction to the second electronic device. FIG. 4 is a flowchart of the control method according to some embodiments of the present disclosure. The method will be described in detail below.

401, obtaining the second input instruction.

402, outputting the second input instruction to the second electronic device.

The second input instruction may be used to control the application state displayed in the third image data. The application displayed in the third image data that prevents the second electronic device from powering off can be closed through the second control instruction such that the second electronic device can power off normally. The second input instruction may be input by the user into the first electronic device through a mouse, a keyboard, a remote control or a touch control. In this way, the first electronic device can obtain the second input instruction and send the second input instruction to the second electronic device.

In some embodiments, after outputting the second image data, the first electronic device may obtain the second input instruction and output the second input instruction to the second electronic device. In this way, the first electronic device can control the application in the second electronic device that affects the power-off of the second electronic device through the second input instruction such that the second electronic device can be powered off normally. In this way, the abnormal powering off of the second electronic device which causes a blue screen on the next startup can be avoided, and the stability of the second electronic device when working in collaboration can be improved.

The following describes the application of the control method provided in the embodiments of the present disclosure in a practical scenario. Take a large-screen system and an open pluggable specification (OPS) computer as an example, where the large-screen system corresponds to the first electronic device and the OPS computer corresponds to the second electronic device.

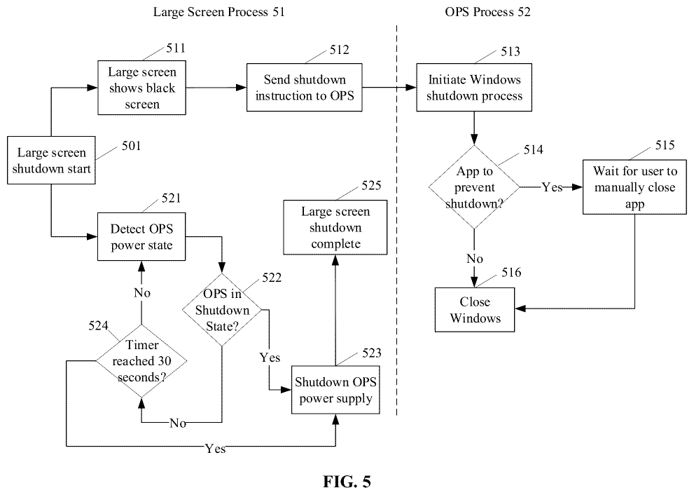

FIG. 5 is a flowchart of the control method according to some embodiments of the present disclosure. As shown in FIG. 5, the control method is used to implement a commonly used shutdown process, including a large screen process 51 and an OPS process 52. The large screen process 51 includes processes 501, 511, 512, and 521-525. The OPS process 52 includes processes 513-516.

501, start the large screen shutdown.

Here, the large screen system starts to shut down.

511, the large screen shows a black screen.

Here, the large screen display device displays a black screen and does not output image data.

512, send a shutdown instruction to OPS.

Here, the large screen sends a shutdown instruction to the OPS, where the shutdown command corresponds to the second control instruction described above.

513, start the Windows shutdown process.

Windows may be the Windows operating system, and the shutdown process of the Windows operating system is initiated.

514, determine whether there is a program preventing the shutdown.

The process at 514 determines whether there is a program in the OPS computer that prevents the OPS from shutting down. If there is a program in the OPS that prevents the shutdown, the process at 515 is executed, otherwise, the process at 516 is executed.

515, wait for the user to manually close the application.

The process at 515 is to wait for the user to manually close the application corresponding to the program that prevents the OPS computer from shutting down, and executing the process at 516 after the user closes the program.

516, close Windows.

521, detect the OPS power state.

The process at 521 is to determine the state of the OPS computer by detecting the OPS power state.

522, determine whether the OPS is in the shutdown state.

The process at 522 determines whether the OPS is in the shutdown state. If the OPS is in the shutdown state, the process at 523 is executed; otherwise, the process at 524 is executed.

523, turn off the power supply of OPS.

In the process at 523, the large screen stops providing power to OPS, and the OPS is shut down.

524, determine whether the timer has reached 30 seconds.

In the process at 524, whether the timer has reached 30 seconds is determined. If the timer has reached 30 seconds, the process at 523 is executed; otherwise, the process at 521 is executed.

525, complete the large screen shutdown.

In the process at 525, the large screen shutdown is completed.

In conventional technology, two issues generally arise from this common shutdown process. The first issue is that since the large screen is black after the shutdown begins, the user cannot be aware of the Windows state in OPS. The second issue is that forcibly powering off the OPS may cause a blue screen when the OPS is turned on the next time.

In some embodiments, the OPS computer may be automatically shut down after the large screen is turned off. If the user sets the power button function in Windows power management to hibernate or sleep mode instead of shutting down, the OPS computer will enter hibernation or sleep mode after receiving the shutdown instruction. However, the step that follows is powered off, and a blue screen will occur at the next restart of the OPS computer.

In some embodiments, the large screen may be automatically turned off after the OPS computer is shut down. When the user selects hibernate or sleep in Windows, the OPS computer will enter hibernation or sleep mode, and then the state indicator pin of the OPS interface will be in the shutdown state (OPS industrial specification only have two states: on and off). When the large screen cannot receive the video signal and detects a change in this pin, it will start to shut down itself. The next time the large screen is turned on, a blue screen will appear on the OPS computer.

Based on this, the present disclosure provides an OPS adapter board power management technology and a mainboard power management technology, and specifically provides a new control method for implementing a new shutdown process. FIG. 6 is a flowchart of the control method according to some embodiments of the present disclosure. As shown in FIG. 6, the control method includes a large screen process 51 and an OPS process 52. The large screen process 51 includes processes 501, 512, 601, 521, 522, 525, 602 and 603. The OPS process 52 includes processes 513-516.

501, start the large screen shutdown.

512, send a shutdown instruction to OPS.

513, start the Windows shutdown process.

514, determine whether there is a program preventing the shutdown.

The process at 514 determines whether there is a program in the OPS computer that prevents the OPS from shutting down. If there is a program in the OPS that prevents the shutdown, the process at 515 is executed, otherwise, the process at 516 is executed.

515, wait for the user to manually close the application.

516, close Windows.

601, pop up a shutdown prompt.

The shutdown prompt may be used to confirm whether the user is sure to shut down the large screen. The shutdown prompt may correspond to the third image data.

521, detect the OPS power state.

522, determine whether the OPS is in the shutdown state.

The process at 522 determines whether the OPS is in the shutdown state. Since the OPS industrial specification only specifies two states: on and off, under the hibernate mode or sleep mode, the state indicator pin of the OPS computer will indicate the shutdown state. In the embodiments of the present disclosure, a new OPS system state detection technology is provided. By redefining and designing the OPS power supply, the four states of OPS power-on, hibernation, sleep, and power-off can be detected, thereby achieving controllable state of OPS. Therefore, the OPS state is determined here to specifically determine whether the OPS is in any of the states of power-on, hibernation, sleep, or power-off. If “Yes”, the process at 525 is executed; otherwise, the process at 602 is executed.

525, complete the large screen shutdown.

602, determine whether the timer has reached 10 seconds.

In the process at 602, whether the timer has reached 10 seconds is determined. If the timer has reached 10 seconds, the process at 603 is executed; otherwise, the process at 521 is executed.

603, switch to the OPS screen.

In the process at 603, the large screen switches the output screen to the screen outputting the OPS state, showing the running state of the application in the OPS and the program preventing the shutdown.

Embodiments of the present disclosure provide a new control method and OPS system state detection technology. Consistent with the present disclosure, when the large screen is shut down, the output screen will be switched to the screen that outputs the OPS state, showing the running state of the application in the OPS and the program that prevents the shutdown. By detecting the four states (power-on, hibernate, sleep, and power-off) of OPS, the current state of OPS can be better understood. In this way, the abnormal shut down of the OPS computer can be avoided to prevent the appearance of a blue screen when the OPS computer is turned on the next time. In this way, the collaboration working capability of the OPS computer and the large screen, and the operational stability are improved.

Embodiments of the present application provide a control device. Units included in the device, modules included in the units, and components included in the modules may be implemented by a processor of the electronic device or a specific logic circuit. In some embodiments, the processor may include a Central Processing Unit (CPU), a Microprocessor Unit (MPU), a digital signal processor (DSP), or a Field Programmable Gate Array (FPGA), etc.

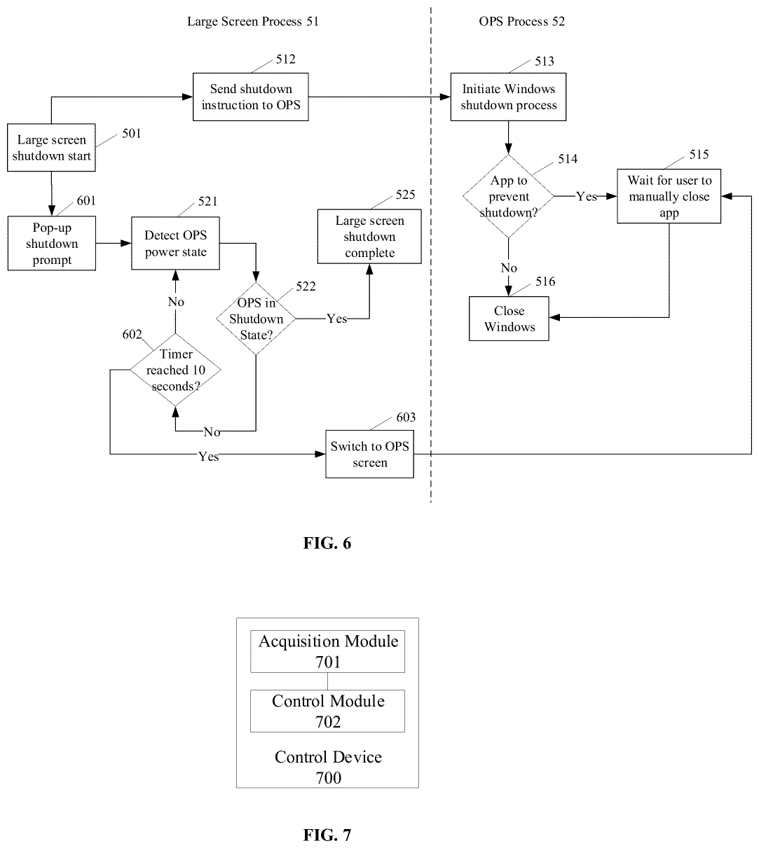

FIG. 7 is a schematic structural diagram of a control device 700 according to some embodiments of the present disclosure. The control device can be applied to a first electronic device. As shown in FIG. 7, the control device 700 includes an acquisition module 701 and a control module 702.

The acquisition module 701 may be configured to obtain a first control instruction. The first control instruction may be used to control the first electronic device to switch from a first state to a second state, the power consumption of the first electronic device in the first state may be greater than the power consumption in the second state.

The control module 702 may be configured to control the first electronic device to switch from outputting the first image data related to the first electronic device to outputting the second image data related to the second electronic device in response to the first control instruction. The second electronic device may be communicatively connected with the first electronic device.

In some embodiments, the acquisition module 701 may be further configured to obtain the state of the second electronic device in response to obtaining the first control instruction.

In some embodiments, the control module 702 may be configured to control an output device 803 to switch to outputting the second image data when the second electronic device is in the third state; and to control the power supply to the second electronic device to stop when the second electronic device is in the fourth state. The power consumption of the second electronic device in the third state may be greater than the power consumption in the fourth state.

In some embodiments, the control module 702 may be further configured to control the first electronic device to be in the second state, or to stop supplying power to the first electronic device when the second electronic device is in the fourth state.

In some embodiments, the control module 702 may be further configured to output the first image data when the duration of the second electronic device being in the third state does not reach the first duration; and switch to outputting the second image data when the duration of the second electronic device being in the third state reaches the first duration.

In some embodiments, the control module 702 may be further configured to control the first electronic device to be in the second state, or stop supplying power to the first electronic device, when the duration for which the state of the second electronic device is not obtained reaches a second duration.

In some embodiments, the control module 702 may be further configured to output a second control instruction to the second electronic device in response to obtaining the first control instruction. The second control instruction may be used to control the second electronic device to switch from the third state to the fourth state, and the power consumption of the second electronic device in the third state may be greater than the power consumption in the fourth state.

In some embodiments, the control module 702 may be further configured to control the output of the first image data and the second image data in the first output mode, and switch to outputting the first image data and the second image data in the second output mode. The first image data may affect the second image data in the first output mode, and the second image data may affect the first image data in the second output mode.

In some embodiments, the control module 702 may be further configured to output the third image data related to the state of controlling the first electronic device in response to the first control instruction. The third image data may affect the first image data.

In some embodiments, the acquisition module 701 may be further configured to obtain a first input instruction related to the third image data.

In some embodiments, the control module 702 may be further configured to control the state of the first electronic device in response to the first input instruction.

In some embodiments, the acquisition module 701 may be further configured to obtain a second input instruction.

In some embodiments, the control module 702 may be further configured to output the second input instruction to the second electronic device.

Consistent with the present disclosure, the control device includes an acquisition module and a control module. Through the acquisition module and the control module, the first electronic device can obtain the first control instruction, control the first electronic device to switch from the first state to the second state, and control the first electronic device to switch from outputting the first image data related to the first electronic device to outputting the second image data related to the second electronic device. In this way, when the first electronic device receives the first control instruction and switches to the second state, the second image data of the second electronic device can be displayed, thereby avoiding abnormal shut down when the state of the second electronic device is unknown, which may cause a blue screen when the device is turned on the next time, and improving the stability of the second electronic device when working in collaboration with the first electronic device.

The descriptions of the above device embodiments are similar to the descriptions of the above method embodiments. Thus, beneficial effects may be included, similar to the beneficial effects of method embodiments. In some embodiments, the functions or modules included in the device provided in the present disclosure can be used to execute the method described in the foregoing method embodiment. For technical details not disclosed in device embodiments of the present disclosure, reference may be made to the descriptions of method embodiments of the present disclosure.

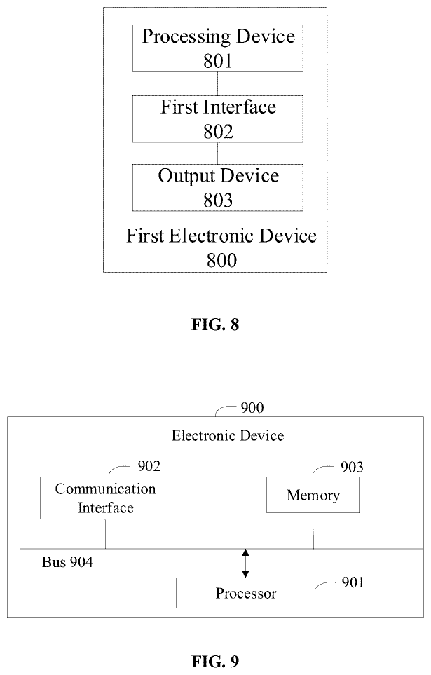

Embodiments of the present disclosure provide a first electronic device 800. As shown in FIG. 8, the first electronic device 800 includes a processing device 801, a first interface 802, and an output device 803. The processing device 801, the first interface 802, and the output device 803, including the modules included therein, and the units included therein, can be implemented by the processor in a terminal. Of course, the implementations can also be realized through a specific logic circuit. In specific implementations, the processor may be a CPU, an MPU, a DSP, a FPGA, or the like.

The processing device 801 may be configured to generate the first image data.

The first interface 802 may be connected to the second electronic device and may be configured to obtain the second image data output by the second electronic device.

The output device 803 may be configured to output the first image data or the second image data.

The processing device 801 may be further configured to obtain the first control instruction. The first control instruction may be used to control the first electronic device 800 to switch from the first state to the second state, and the power consumption of the first electronic device 800 in the first state may be greater than the power consumption in the second state. In addition, in response to the first control instruction, the output device 803 may switch from outputting the first image data to outputting the second image data.

In some embodiments, the processing device 801 may be further configured to obtain the state of the second electronic device in response to obtaining the first control instruction. The output device 803 may control the output device 803 to switch to outputting the second image data when the second electronic device is in the third state; and to control the power supply to the second electronic device to stop when the second electronic device is in the fourth state. The power consumption of the second electronic device in the third state may be greater than the power consumption in the fourth state.

In some embodiments, the processing device 801 may be further configured to control the first electronic device 800 to be in the second state, or stop the power supply to the first electronic device 800, when the second electronic device is in the fourth state.

In some embodiments, the processing device 801 may be further configured to control the output device 803 to output the first image data when the duration of the second electronic device being in the third state does not reach the first duration; and to control the output device 803 to switch to outputting the second image data when the duration of the second electronic device being in the third state reaches the first duration.

In some embodiments, the processing device 801 may be further configured to control the first electronic device 800 to be in the second state, or stop supplying power to the first electronic device 800, when the duration for which the state of the second electronic device is not obtained reaches the second duration.

In some embodiments, the processing device 801 may be further configured to output a second control instruction to the second electronic device in response to obtaining the first control instruction. The second control instruction may be used to control the second electronic device to switch from the third state to the fourth state, and the power consumption of the second electronic device in the third state may be greater than the power consumption in the fourth state.

In some embodiments, the processing device 801 may be further configured to control the output of the first image data and the second image data in the first output mode, and switch to outputting the first image data and the second image data in the second output mode. The first image data may affect the second image data in the first output mode, and the second image data may affect the first image data in the second output mode.

In some embodiments, the processing device 801 may be further configured to output the third image data related to controlling the state of the first electronic device 800 in response to the first control instruction, the third image data affecting the first image data; obtain a first input instruction related to the third image data; and control the state of the first electronic device 800 in response to the first input instruction.

In some embodiments, the processing device 801 may be further configured to obtain a second input instruction, and output the second input instruction to the second electronic device.

Consistent with the present disclosure, the first electronic device includes a processing device, a first interface, and an output device. Through the connection between the first interface and the second electronic device, the second image data output by the second electronic device can be obtained, and the first image data or the second image data can be output through the output device. The first image data can be generated through the processing device. The first control instruction can be obtained to control the first electronic device to switch from the first state to the second state, and to control the output device to switch from outputting the first image data to outputting the second image data. In this way, the second image data of the second electronic device can be displayed by the first electronic device, thereby avoiding the abnormal shut down when the state of the second electronic device is unknown, which may cause a blue screen when the second electronic device is turned on next time, and improving the stability of the second electronic device when working in collaboration with the first electronic device.

The descriptions of the above first electronic device embodiments are similar to the descriptions of the above method embodiments. Thus, beneficial effects may be included, similar to the beneficial effects of method embodiments. In some embodiments, the functions or modules included in the device provided in the present disclosure can be used to execute the method described in the foregoing method embodiment. For technical details not disclosed in device embodiments of the present disclosure, reference may be made to the descriptions of method embodiments of the present disclosure.

In embodiments of the present disclosure, if the above method is implemented in the form of a software function module, the method may be implemented by computer instructions stored in a computer-readable storage medium. In some embodiments, a functional module may be implemented by a combination of software and hardware components. Thus, the essence or the part that makes contributions to the existing technology of the technical solutions of the embodiments of the present application may be embodied in the form of software components or software components and hardware components. The computer software components may be stored in a storage medium and include several instructions to cause the electronic apparatus (i.e., a personal computer, a server, etc.) to execute all or part of the methods of embodiments of the present disclosure.

The present disclosure also provides a computer-readable storage medium storing the computer program that, when executed by the processor, causes the processor to implement the method above. The computer-readable storage medium can be transient or non-transient.

Embodiments of the disclosure provide a computer program, including computer-readable codes that, when running on an electronic device, cause a processor in the electronic device to implement some or all of the steps for implementing the foregoing method.

Embodiments of the present disclosure provide a computer program product, including a non-transient computer-readable storage medium storing the computer program that, when read and executed by a computer, causes the computer to perform some or all of the steps of the method above. The computer program product can be implemented by hardware, software, or a combination thereof. In some embodiments, the computer program product can be embodied as a computer storage medium. In some other embodiments, the computer program product can be embodied as a software product, such as a software development kit (SDK).

FIG. 9 is a schematic diagram of the hardware of an electronic device 900 according to some embodiments of the present disclosure. The electronic device 900 may be the first electronic device or the second electronic device. As shown in FIG. 9, the hardware of the electronic device 900 includes a processor 901, a communication interface 902, a memory 903, and a bus 904.

The processor 901 generally controls the overall operation of the electronic device 900. The communication interface 902 can enable the terminal to communicate with other terminals or servers through a network. The memory 903 may be configured to store instructions and/or applications executable by the processor 901, and may also cache data to be processed or processed by the processor 901 and various modules in the electronic device 900 (for example, image data, audio data, voice communication data and video communication data). The memory may be implemented through flash memory (FLASH) or random-access memory (RAM). Data can be transmitted between the processor 901, the communication interface 902 and the memory 903 via the bus 904.

In the present disclosure, description with reference to the terms “one embodiment,” “some embodiments,” “example,” “specific example,” or “some examples,” etc., means that specific features described in connection with the embodiment or example, structure, material or feature is included in at least one embodiment or example of the present disclosure. Furthermore, the particular features, structures, materials or characteristics described may be combined in any suitable manner in any one or more embodiments or examples. Furthermore, those skilled in the art may combine the different embodiments or examples described in this specification, as well as the features of the different embodiments or examples, without conflicting each other. In various embodiments of the present disclosure, the size of the sequence numbers of the above-mentioned processes does not mean the sequence of execution, and the execution sequence of each process should be determined by its functions and internal logic, rather than the implementation process of the embodiments of the present disclosure. The above-mentioned serial numbers of the embodiments of the present application are only for description, and do not represent the advantages or disadvantages of the embodiments.

In the present disclosure, the terms “comprising,” “including” or any other variation thereof are intended to encompass a non-exclusive inclusion such that a process, method, article or device comprising a list of elements includes not only those elements, but also others not expressly listed elements, or also include elements inherent to such a process, method, article or apparatus. Without further limitation, an element qualified by the phrase “comprising a . . . ” does not preclude the presence of additional identical elements in a process, method, article or apparatus that includes the element.

In the several embodiments provided in this disclosure, it should be understood that the disclosed device and method may be implemented in other ways. The device embodiments described above are only exemplary. For example, the division of the units is only a logical function division. In one embodiment, there may be another division manner, for example, multiple units or components may be combined, or may be integrated into another system, or some features can be ignored or not implemented. In addition, the displayed or discussed components may be coupled, directly coupled, or connected to each other via some interfaces, coupling or connections of the devices or units, and may be electrical, mechanical, or other forms.

The above separate components may or may not be physically separated. The display components may or may not be physical units, and they may be located in one place or may be distributed on multiple network units. Some or all of the units need to be selected to achieve the objective of the solution of this embodiment.

In addition, the functional units in the embodiments of the present disclosure may all be integrated into one processing unit; or each unit may be separately used as a unit; or two or more units may be integrated into one unit. The above integrated units can be implemented in the form of hardware, or in the form of hardware plus software functional units.

A person of ordinary skill in the art may understand that all or part of the steps of the foregoing method embodiments may be implemented by a related hardware which is instructed by a program. The foregoing program may be stored in a readable storage medium. When the program is executed, the steps of the above method embodiments are performed. The foregoing storage medium includes various storage mediums that can store programs such as a mobile storage device, a read-only memory (ROM), a random-access memory (RAM), a magnetic disk, or an optical disk.

Alternatively, if the above-mentioned integrated unit of the present disclosure is implemented in the form of a software module and sold or used as an independent product, it may also be stored in a readable storage medium. Based on such an understanding, the technical solutions of the embodiments of the present disclosure that are essential to or contribute to the existing technology can be embodied in the form of a software product. A module may refer to computer programs stored in a storage medium and, when executed by one or more processors, the software module implements and executes all or part of the functions and methods described in relation to the module. A module may also be a combination of software and hardware components that implements and executes all or part of the functions and methods described in relation to the module. The foregoing storage medium includes various types of mediums that can store program codes, such as a mobile storage device, a ROM, a RAM, a magnetic disk, or an optical disc.

The above is a detailed description of the embodiments of the present disclosure, but does not limit the protected scope of the present disclosure. Any variation or substitution made by a person skilled in the art within the technical scope disclosed in the present disclosure should be covered by the protected scope of the present disclosure. Therefore, the protected scope of the present disclosure shall conform to the protected scope of the addended claims.

What is claimed is:

1. A control method comprising:
outputting first image data of a first electronic device;
obtaining a first control instruction, the first control instruction being used to control the first electronic device to switch from a first state to a second state, power consumption of the first electronic device in the first state being greater than the power consumption in the second state; and
switching to outputting second image data of a second electronic device, the second electronic device being communicatively connected with the first electronic device.

2. The method of claim 1 further comprising:
obtaining a state of the second electronic device in response to obtaining the first control instruction;
switching to outputting the second image data when the second electronic device is in a third state; and
controlling to stop supplying power to the second electronic device when the second electronic device is in a fourth state, wherein:
the power consumption of the second electronic device in the third state is greater than the power consumption in the fourth state.

3. The method of claim 2 further comprising:
controlling the first electronic device to be in the second state, or stop supplying power to the first electronic device when the second electronic device is in the fourth state.

4. The method of claim 2 further comprising:
outputting the first image data when a duration of the second electronic device being in the third state does not reach a first duration; and
switching to outputting the second image data when the duration of the second electronic device being in the third state reaches the first duration.

5. The method of claim 2 further comprising:
controlling the first electronic device to be in the second state, or stopping to supply power to the first electronic device if the duration for which the state of the second electronic device is not obtained reached a second duration.

6. The method of claim 1 further comprising:
outputting a second control instruction to the second electronic device in response to obtaining the first control instruction, wherein:
the second control instruction is used to control the second electronic device to switch from a third state to a fourth state, and the power consumption of the second electronic device in the third state is greater than the power consumption in the fourth state.

7. The method of claim 1, wherein switching to outputting the second image data of the second electronic device includes:
controlling the output of the first image data and the second image data in a first output mode, and switching to output the first image data and the second image data in a second output mode; in the first output mode, the first image data affects the second image data, and in the second output mode, the second image data affects the first image data.

8. The method of claim 1 further comprising:
outputting third image data related to the state of controlling the first electronic device in response to the first control instruction, the third image data affecting the first image data;
obtaining a first input instruction related to the third image data; and
controlling the state of the first electronic device in response to the first input instruction.

9. The method of claim 1, after switching to outputting the second image data of the second electronic device, the method further comprising:
obtaining a second input instruction; and
outputting the second input instruction to the second electronic device.

10. A control device comprising:
an acquisition module, the acquisition module being configured to obtain a first control instruction, the first control instruction being used to control a first electronic device to switch from a first state to a second state, power consumption of the first electronic device in the first state being greater than the power consumption in the second state; and
a control module, the control module being configured to control the first electronic device to switch from outputting first image data related to the first electronic device to outputting second image data related to a second electronic device in response to the first control instruction, the second electronic device being communicatively connected with the first electronic device.

11. The device of claim 10, wherein:
the acquisition module is further configured to obtain a state of the second electronic device in response to obtaining the first control instruction.

12. The device of claim 10, wherein:
the control module is further configured to control to switch output the second image data when the second electronic device is in a third state, and control to stop supplying power to the second electronic device when the second electronic device is in a fourth state, the power consumption of the second electronic device in the third state being greater than the power consumption in the fourth state.

13. The device of claim 12, wherein:
the control module is further configured to control the first electronic device to be in the second state, or stop supplying power to the first electronic device when the second electronic device is in the fourth state.

14. The device of claim 11, wherein:
the control module is further configured to output the first image data when a duration of the second electronic device being in the third state does not reach a first duration, and switch to output the second image data when the duration of the second electronic device being in the third state reaches the first duration.

15. The device of claim 11, wherein:
the control module is further configured to control the first electronic device to be in the second state, or stopping to supply power to the first electronic device if the duration for which the state of the second electronic device is not obtained reached a second duration.

16. The device of claim 10, wherein:
the control module is further configured to output a second control instruction to the second electronic device in response to obtaining the first control instruction, the second control instruction being used to control the second electronic device to switch from a third state to a fourth state, and the power consumption of the second electronic device in the third state being greater than the power consumption in the fourth state.

17. The device of claim 10, wherein:
the control module is further configured to control the output of the first image data and the second image data in a first output mode, and switch to output the first image data and the second image data in a second output mode; in the first output mode, the first image data affects the second image data, and in the second output mode, the second image data affects the first image data.

18. The device of claim 10, wherein:
the control module is further configured to output third image data related to the state of controlling the first electronic device in response to the first control instruction, the third image data affecting the first image data.

19. The device of claim 18, wherein:
the acquisition module is further configured to obtain a first input instruction related to the third image data; and
the control module is further configured to control the state of the first electronic device in response to the first input instruction.

20. A first electronic device comprising:
a processing device, the processing device being configured to generate first image data;
a first interface connected to a second electronic device, and used to obtain second image data output by the second electronic device; and
an output device, the output device being configured to output the first image data or output the second image data, wherein:
the processing device is further configured to obtain a first control instruction, the first control instruction being used to control a first electronic device to switch from a first state to a second state, power consumption of the first electronic device in the first state being greater than the power consumption in the second state; and control the output device to switch from outputting the first image data to outputting the second image data in response to the first control instruction.
